(19) United States
(12) Patent Application Publication
(10) Pub. No.: US 2026/0012445 A1
(43) Pub. Date: Jan. 8, 2026

(54) METHOD FOR SECURELY GENERATING A TOKEN WHICH CAN BE ISSUED, METHOD FOR SECURELY DESTROYING A TOKEN, AND TOKEN ISSUER

(71) Applicant: GIESECKE+DEVRIENT ADVANCE52 GMBH, Munchen (DE)

(72) Inventors: Lucas DOHMEN, Simmerath (DE); Matthias FASCHING, Unterhaching (DE); Klaus ALFERT, St. Augustin (DE)

(21) Appl. No.: 18/993,206

(22) PCT Filed: Jun. 14, 2023
(86) PCT No.: PCT/DE2023/100452

§ 371 Date: Jan. 10, 2025

(30) Foreign Application Priority Data
Jul. 11, 2022 (DE) 10 2022 002 518.3

(51) Int. Cl. H04L 9/40; G06Q 20/36

(52) U.S. Cl. CPC H04L 63/0807; G06Q 20/367

(57) ABSTRACT

A method is described for securely generating a token that can be issued by a token issuer within an electronic transaction system, which includes a token reference register. This method also covers the secure destruction of a token in the same system, featuring both a token reference register and a token issuer. In a token issuer unit equipped with a secure token generating unit, the following steps are performed: a unique token element pair is generated, consisting of a secret token element and a public token reference element; an addition command is created that instructs the token reference register to add the generated public token reference element as an additional token reference in the token reference register; and the addition command is then transmitted to the token reference register.

The invention relates to a method for securely generating a token which can be issued by a token issuer of an electronic transaction system with a token reference register. The invention also relates to a method for securely destroying a token of an electronic transaction system with a token reference register. The invention also relates to a token issuer.

For token-based transaction systems, it is known to provide a token reference register. The token issuer can initially register a token reference of a token which can be issued in the token reference register or can delete an already registered token reference of a token to be withdrawn. In contrast, subscribers of the transaction system may, for example, only register a token reference of the token in exchange for an already registered token reference of an equal-value token.

In central bank digital currency systems (CBDC systems), particularly high security requirements are imposed on the central system components, for example on the token issuer.

WO 2022/008319 A1 describes a token issuer comprising an isolated token generation unit and a token output unit. A private key of a cryptographic key pair of the token issuer can be stored in a hardware security module of the token generation unit. On request of the token output unit, the token generation unit generates a new token and a signed registration data record which makes it possible to register the new token by means of a token reference in the token reference register. The token output unit receives the token to be issued and the token registration data record. It registers the token to be issued by means of the token registration data record in the token reference register before it outputs the new token to a subscriber unit of the transaction system.

The invention is now based on the object of providing a still secure token issuer unit and a particularly secure method for securely generating or destroying tokens of the transaction system. The solution should preferably be flexible without endangering security in the transaction system.

The stated object is achieved by the subject matter of the independent patent claims. Further advantageous configurations are described in the respectively dependent patent claims.

In a first aspect, the object is achieved in particular by means of a method for securely generating a token which can be issued by a token issuer of an electronic transaction system with a token reference register. In a token issuer unit comprising a secure token generation unit, the following steps are carried out: generating a token-specific token element pair, comprising a secret token element and a public token reference element, in the secure token generation unit; generating an add command in the secure token generation unit, said command instructing the token reference register to add a token reference comprising the generated public token reference element as an additional token reference in the token reference register; sending the add command to the token reference register. The generated token element pair is an internal temporary token element pair of the token generation unit. The token generation unit receives a token reference of the token which can be issued. The token generation unit generates a replace command which instructs the token reference register to register the token reference of the token which can be issued instead of the token reference of the temporary token element pair.

A token contains a token value as token element.

In one configuration, the token issuer unit comprises a secure token storage unit (hereinafter also token issuer subscriber unit), wherein this secure token storage unit generates a token-specific token element pair of the token which can be issued.

In one configuration, the secret token element of the internal temporary token element pair is present only in the token generation unit and/or the secret token element of the token which can be issued is present only in the token generation unit.

A token contains a secret token element of the token element pair. A token reference contains a public token reference element of the token element pair. The public token reference element is uniquely assigned to a token and/or is derived from the secret token element of the token element pair. In one configuration, the secret token element is a random number and the public token reference element is the result of a cryptographic function on the secret token element. In one configuration, the secret token element is a private key of a cryptographic key pair and the public token reference element is the public key of the cryptographic key pair.

The token value of the internal temporary token corresponds to the token value of the token to be issued. The token value can be transmitted as information from a token issuer management means, which is a unit of the token issuer unit, to the token generation unit. Alternatively, token values with fixed denominations are generated.

By means of this method, the internal temporary token generated in the token generation unit by a generating step is not transmitted directly to the token management unit. It is advantageous for the first aspect that, after generating the internal temporary token, the token generation unit generates a replace command (in particular a token-value-neutral replacement, for example by means of a switching modification, a merging modification (with a token of the value “0”) or a splitting modification (receipt of a token with the value “0”)) in order to reference a (new) token to be issued. For this purpose, the public token reference element (R) of the token element pair (r, R) required for the replacement is provided, for example, by the token issuer management unit (a unit of the token issuer unit) or a bank subscriber unit or a central bank subscriber unit.

When the token reference of the new token to be issued has been registered with the token reference register, the new token is valid in the transaction system and can be used.

In one configuration, the token issuer holds tokens which can be newly issued (but have not yet been issued) in a secure storage area (for example in the token issuer subscriber unit). On request from a subscriber unit, for example a bank subscriber unit of the transaction system, the token which can be issued can then be output immediately (without having to carry out the secure generation method first) to the requesting subscriber unit in the transaction system.

In an alternative configuration, before the token-specific token element pair is generated, a token generation request can be received, preferably in a secure token issuer management means of the token issuer unit.

This token generation request can have been sent by a subscriber unit, for example a bank subscriber unit of the transaction system. Alternatively, this token generation request may have been sent by a central bank entity.

CDBC wallets may be present in the subscriber units, for example a bank subscriber unit of the transaction system, which interact with the token issuer unit for ordering (request, generation) or returning (redemption, destruction) CDBC.

Preferably, in the generating step, the token which can be issued is signed with a private key of the token issuer unit, for example with a private key of the token generation unit. By virtue of the signature with the private key part, each subscriber unit of the transaction system can now use the associated public key part to check whether the token has been generated in a trustworthy manner. This ensures that the token has been issued by a token issuer and not by an attacker. As a result of the method according to the invention, neither the key part of the cryptographic key pair of the token issuer unit nor the secret token element leaves the token generation unit. It is thus possible to break the token issuer down modularly into a token issuer management unit and a token generation unit. Both units of the token issuer unit can now be arranged locally remote from one another without security being impaired. With the spatial remoteness, the token issuer unit can be constructed more flexibly and more modularly.

Preferably, in the replace command generating step, the new token is signed with the private part of the temporary token-specific cryptographic key pair. Thus, the token generation unit indicates that it was aware of the temporary token and the new token. This signature may be a mandatory specification for the replace command.

In order to register the token which can be issued, the replace command in the token reference register is preferably checked for validity by checking a signature of the token issuer unit by means of a public key part of the token issuer unit.

Preferably, the registration request in the token reference register is also checked for validity by checking a signature by means of the public token reference element of the token element pair.

The add command and the replace command are preferably sent together to the token reference register in a joint sending step. As a result of the joint sending, an addition confirmation (generated by the token reference register) and/or a replacement confirmation (generated by the token reference register) is/are received in the token issuer unit.

The token reference register preferably sends a registration confirmation (=replacement confirmation) if the replace command is valid.

After receiving the registration confirmation (=replacement confirmation), the token issuer management unit of the token issuer unit preferably transmits the token to be newly issued and having the token value and the secret token element of the token element pair to a subscriber unit, preferably a bank subscriber unit.

In a second aspect, a method for securely destroying a token by a token issuer of an electronic transaction system with a token reference register is provided, wherein, in a token issuer unit comprising a secure token destruction unit, the following steps are carried out: generating a remove command in the token destruction unit, said command instructing the token reference register to remove a token reference of a registered token from the token reference register; and sending the remove command to the token reference register. The token destruction unit generates an internal temporary token before generating the remove command and generates the remove command for the token reference of the internal temporary token. In addition, a replace command which instructs the token reference register to register the token reference of the internal temporary token instead of the token reference of the token to be withdrawn is generated.

In analogy to the secure generation of a token according to the first aspect, the second aspect is now directed to destroying (deleting) a token in the transaction system. Advantages and technical objects correspond to those of the first aspect.

In particular, by means of the method according to the second aspect, the internal temporary token generated in the token destruction unit by a generating step is not transmitted directly to the token management unit. It is advantageous for the second aspect that, after generating the internal temporary token, the token destruction unit generates a replace command (in particular a token-value-neutral replacement, for example by means of a switching modification, a merging modification (with a token of the value “0”) or a splitting modification (receipt of a token with the value “0”)) in order to register the token reference of the internal temporary token instead of the token reference of the token to be withdrawn (to be destroyed). For this purpose, the token reference of the token to be withdrawn, which is required for the replacement, is provided, for example, by the token issuer management unit (a unit of the token issuer unit) or a bank subscriber unit or a central bank subscriber unit.

In order to be able to prevent the token to be destroyed (=to be deleted) from being stolen during transfer to the token issuer destruction unit, a replace command is combined according to the invention with the remove command.

The token issuer unit comprises a secure token storage unit, wherein the secure token storage unit deactivates the token to be withdrawn.

The secret token element of the internal temporary token is preferably present only in the token destruction unit.

The remove command and the replace command may be sent together to the token reference register in a joint sending step. As a result of the sending, a removal confirmation (generated by the token reference register) and/or a replacement confirmation (generated by the token reference register) can be received in the token issuer unit.

The token issuer unit may comprise a secure token management unit, wherein a token destruction request is received in the token management unit.

In one configuration, the token to be destroyed (to be deleted, withdrawn) was taken from a deletion directory of the token issuer management means. This deletion directory is a storage area in the token issuer unit, in which subscriber units of the transaction system store tokens to be deleted (i.e. to be redeemed).

In a highly preferred configuration, an air gap interface is realized between the token generation unit and the token issuer management means. Here, an air gap or air wall (in analogy to a firewall) process refers to a process which separates the two units (token generation unit and token issuer management means) from one another, but nevertheless allows the transmission of useful data, here tokens, token elements, token element pairs, key parts etc. An air gap process is used here to isolate the two differently trustworthy units from one another, but nevertheless to ensure that data from the respective other unit can be processed.

In a preferred configuration, the air gap transmission is configured to physically, logically, electrically and/or electronically separate the token generation unit from the token issuer management means. Both units are thus electrically isolated from one another in terms of the form. In other words: Data transmission does not take place exclusively electrically/electronically. Thus, an attacker with remote network access to the token issuer management means has no access to the token generation unit. It is therefore not possible for the attacker to introduce data into the token generation unit and/or to tap data (for example the temporary token or the private part of the token issuer key pair) from the token generation unit. In this respect, there is no (permanent, physical) data connection (OSI layer 1) between the token generation unit and the token issuer management means.

In a preferred configuration, the transmission in the air gap process is performed using portable electronic data memories, such as a USB stick, memory card, CD, or the like. For this purpose, corresponding electronic interfaces, such as a USB connection, memory card reader or CD drive, are provided on the token generation unit and the token issuer management means.

In a preferred configuration, for transmission in the air gap process, the token generation unit is further configured to generate a printout representing the token (as a physical representative of a token). The token issuer management means is configured to read in the token printout generated by the token generation unit. This represents a comparatively simple form of implementing an air gap process. The printout can be transported, for example, via mechanical conveying mechanisms into a read-in area of the token issuer management means. The transport boxes already described can also be used for this purpose, such that, for example, a printout is arranged automatically by the token generation unit in a transport box, is then transported to the token issuer management means, in particular the reading area thereof, and is read in there.

In a preferred configuration, all tokens to be deleted within a predefined time period are deleted as batch processing at the end of the predefined time period. As a result, the transmission steps are reduced at only one specific time within a, thus greatly minimizing the outlay—in particular in the case of air-gap processes.

Preferably, all tokens to be deleted within a predefined time period are combined at the end of the predefined time period to form a common delete token by applying one or more merge commands before carrying out the method according to the second aspect. The number of transmission steps is thus reduced enormously, whereupon the outlay for generating and/or deleting tokens

Preferably, the predefined time period is one month, preferably one week, more preferably one day, further preferably one hour.

Preferably, the token reference register sends an addition confirmation if the add command is valid and the temporary token reference has been added in the token reference register. The token issuer unit, in particular the secure token issuer management unit, thus learns that the temporary token reference is present in the token reference register.

An electronic transaction system, for example a digital currency system or a digital central bank system, is a system in which at least two, preferably a multiplicity of subscriber units, can exchange (transmit) central bank digital money (CDBC) in the form of tokens directly with one another. The transaction system is thus, for example, a payment transaction system for exchanging monetary amounts in the form of payment tokens.

A token is a data record of a transaction system that can be exchanged directly between subscriber units. When a token reference is registered in the token reference register, the token is considered to be generated and/or deleted and/or transmitted, and, from this point in time, a receiving subscriber unit is in possession of the token value represented by the token. With the transmission process, the token accordingly automatically changes the owner (from issuer to subscriber unit). A token—a data record that can be transmitted independently of a transaction topology, such as blockchain topologies “Bitcoin”, “Ethereum” or “Neo”—can be transmitted directly between subscriber units or from the token issuer without interposed units.

In one configuration, the token is an electronic coin data record or payment token in order to exchange monetary amounts between subscriber units. Colloquially, such a payment token is also referred to as a “digital coin” or “electronic coin” and represents cash in electronic form.

Each token in the transaction system is a data record comprising at least two token elements.

A first token element of each token of the transaction system is a token value, for example an asset value, an asset, a commodity and/or a monetary amount.

A second token element of each token of the transaction system is a secret token element of the token element pair, for example the private part of a token-specific key pair. This private part is a secret in the transaction system and is not published and must not be used repeatedly. The generation of the private part must not be predictable. This private part may be a random number. The random number is preferably the result of a true random number generator.

The token is formed from the token value (first token element) and the secret token element. This forming is preferably the concatenation of these two token elements. Any other type of combination of these two token elements is not excluded according to the invention and comprises, for example, successive attachment, introduction into a TLV data structure and/or logical combination.

The token differs from a data record for conventional data exchange or data transfer, since, for example, conventional data exchange takes place on the basis of a question-answer principle or intercommunication between the data exchange partners. A token is, in contrast, unique and unambiguous in the transaction system. The token is in the context of a security concept which comprises signatures or cryptographic encryptions, for example. A token contains all data elements which are required for a receiving subscriber unit with regard to verification, authentication and forwarding of the token to another subscriber unit. Therefore, in principle, intercommunication between the subscriber units transmitting a token is not required for a token.

Anyone in possession of a token or with unrestricted access to the token with its token elements can exchange (=transmit) this token with another subscriber unit. Possession of the token with its at least two token elements (token value and private part of the token-specific key pair) is thus equivalent to possession of the value represented by the token. Here, the token can also be transmitted indirectly by registering a token reference.

Each token in the transaction system is assigned a token reference. This assignment is biunique, that is to say exactly one token reference is assigned to a token and exactly one token is assigned to each token reference. The token reference is a public data record which is stored in a verifiable manner for each subscriber unit in a storage unit of the token reference register of the transaction system.

Both the token and the token reference are unique. The biunique assignment results in a 1-to-1 relationship between the token and the token reference.

Each token reference in the transaction system is a data record comprising at least two token reference elements.

A first token reference element of each token reference is the token value of the token uniquely assigned to the token reference. The token value of the token is thus identical to the token value of the assigned token reference. By way of example, the token value of the token reference is a copy of the token value of the assigned token.

A second token element of each token reference of the transaction system is a public token reference element of the token element pair, for example a public part of the token-specific key pair. This public part of the token reference forms, together with the private part of the token, the token-specific key pair. The public part is obtained by applying a cryptographic function to the private part. In other words: The public token reference element and the private token element form the token element pair.

This cryptographic function is a one-way function. Accordingly, this cryptographic function is a mathematical function that is “easy” to calculate in terms of complexity theory, but is “difficult” to practically impossible to reverse. In this case, a one-way function also denotes a function for which there has hitherto been no known reversal that can be performed in practice within a reasonable time and with reasonable effort. Preferably, use is made of a one-way function which operates on a group in which the discrete logarithm problem is difficult to solve, for example a cryptographic method analogous to an elliptic curve encryption, ECC for short, from a private key of a corresponding cryptographic method. The reverse function, that is to say the generation of a token (or of the part of the electronic coin data record) from a token reference, is very time-consuming in this case.

The (mere) knowledge or possession of a token reference does not authorize the owner to use/transmit/output the token value (token reference element). This represents a significant difference between the token reference and the token and is a core element of the present invention.

After applying the cryptographic function to the private part of the token-specific key pair, the public part of the token-specific key pair is obtained as the second token reference element.

The token reference is formed from the token value (first token reference element) and the public part. This forming is preferably the concatenation of these two token reference elements. Any other type of combination of these two token reference elements is not excluded according to the invention and comprises, for example, successive attachment, introduction into a TLV data structure and/or logical combination.

A token reference can also be generated by an electronic wallet. The use of a token reference is not comparable to the use of addresses of subscriber units in a blockchain-based transaction system, since no addresses of the subscriber units are used in the token reference register according to the invention to prevent traceability of the tokens.

The method for registering provides a receiving step for receiving a token reference in a token reference register as part of a registration request. For example, the registration request is sent by a subscriber unit or the token issuer management means (here as an add command and a replace command) of the transaction system.

The token reference register is a unit of the transaction register in which token references are stored, as a result of which the associated tokens are registered. This register may be a central database or storage unit. This register can be a decentralized ledger, for example in a blockchain topology. The token reference register may keep a record of a history of the token references and/or the registration requests.

The received registration request is verified by a verification unit in the token reference register. In this case, it is verified whether the at least one token reference of the received registration request has already been stored in the token reference register. A token reference is stored only once in the token reference register. Since a token reference of a token is present only once in the transaction system, a verification step can be used to determine whether an attempt has been made to output a token multiple times. In one configuration, the verification step determines whether signature(s) of the registration request is/are correct.

To replace the token, a switching modification can be applied; for a switching modification, the following method steps are carried out: receiving the token reference from the token issuer for the (new) token to be generated; generating a registration request comprising the token reference of the temporary token and the token reference for the new (generated) token. The switching of the token is a modification option for modifying a token. The token references contained in the registration request can be joined to one another by means of concatenation. If a token is transmitted from one subscriber unit directly to another subscriber unit, for example if the monetary amount is intended to be transmitted as a token value during a payment transaction, the transmitting subscriber unit can now have the token value re-registered to itself. The switch is thus registered in the token reference register.

The token value of the temporary token corresponds to the token value of the new token. Accordingly, during switching, a token with the same token value but a new private part is registered in the token reference register.

The token reference register has knowledge of token references of tokens of the transaction system and preferably also has a record of the processing or modifications to the token (token history). The transactions with the tokens are not registered in the token reference register and take place directly between subscriber units of the transaction system in a direct transaction layer of the transaction system.

In a further aspect, a token issuer unit of a transaction system is provided. The token issuer unit may comprise: an interface to a token reference register; and a secure token generation unit for securely generating a token which can be issued by means of a method according to the first aspect; and/or a secure token destruction unit for securely destroying a token by means of a method according to the second aspect.

The token issuer unit may further comprise a token issuer subscriber unit configured to store tokens and/or token references; and an interface to a bank subscriber unit or to a central bank unit, configured to receive a token generation request and/or to receive a token destruction request.

The token issuer unit may further comprise a token management unit with an interface to a bank subscriber unit or to a central bank unit or to a token issuer subscriber unit, configured to output the token which can be issued and/or store completion of the secure destruction of the token and/or store completion of the secure generation of the token which can be issued.

The token issuer unit may further comprise an air gap interface between the token management unit and the secure token generation unit and/or the secure token destruction unit.

The token issuer preferably comprises an air gap interface between the token issuer management means and the token generation unit for at least one of the transmission steps of the method according to the first and/or second aspect.

The token reference register may be an entity of a central currency system, and each token may be digital central bank money. A digital currency system as the transaction system comprises a multiplicity of the described subscriber units, the token reference register and a token issuer.

A subscriber unit, for example a bank subscriber unit or an issuer subscriber unit, may be in the present case a secure element which has secure access to one or more tokens in a token memory. The secure element is installed, for example, in a terminal in a ready-to-operate manner. The secure element and/or the terminal has/have a special computer program product (electronic wallet), in particular in the form of a secured runtime environment within an operating system of a terminal, known as a Trusted Execution Environment TEE, stored in a data memory, for example of a mobile terminal, a machine or an ATM. Alternatively, the secure element is designed, for example, as special hardware, in particular in the form of a secured hardware platform module, known as a Trusted Platform Module TPM, or as an embedded security module, eUICC, eSIM. The secure element provides a trusted environment.

The invention and further embodiments and advantages of the invention are explained in more detail below with reference to figures, wherein the figures merely describe exemplary embodiments of the invention. The same components in the figures are provided with the same reference signs. The figures should not be considered to be true to scale; individual elements of the figures may be illustrated so as to be overly large or overly simplified.

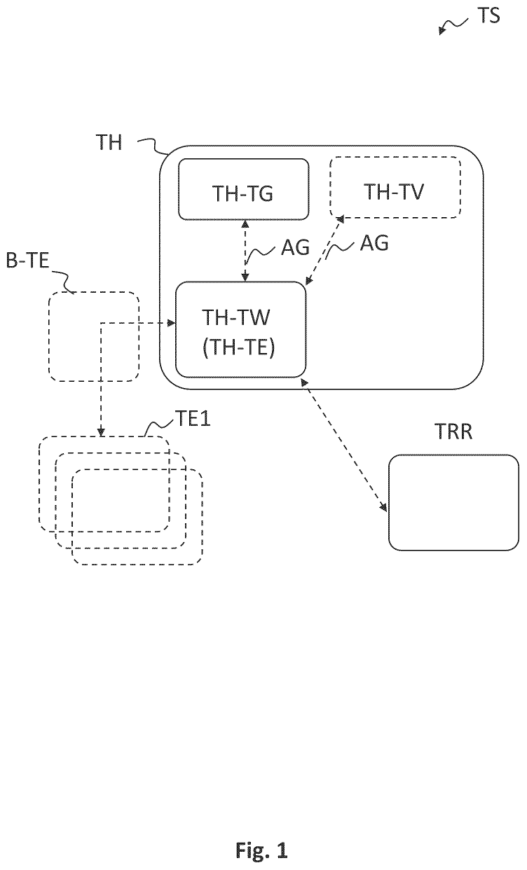

FIG. 1 shows one exemplary embodiment of a token issuer unit;

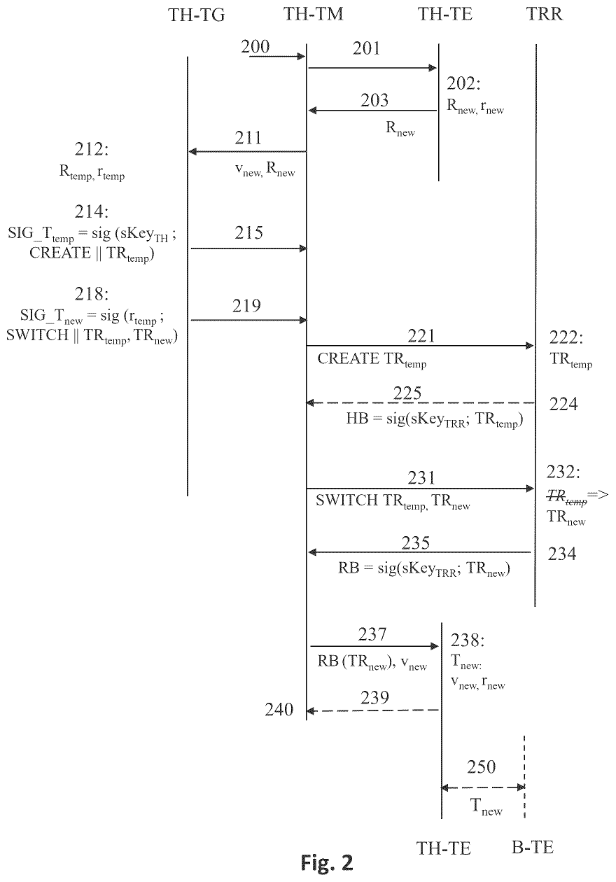

FIG. 2 shows one exemplary embodiment of a sequence of steps of a method according to the first aspect in a token issuer unit;

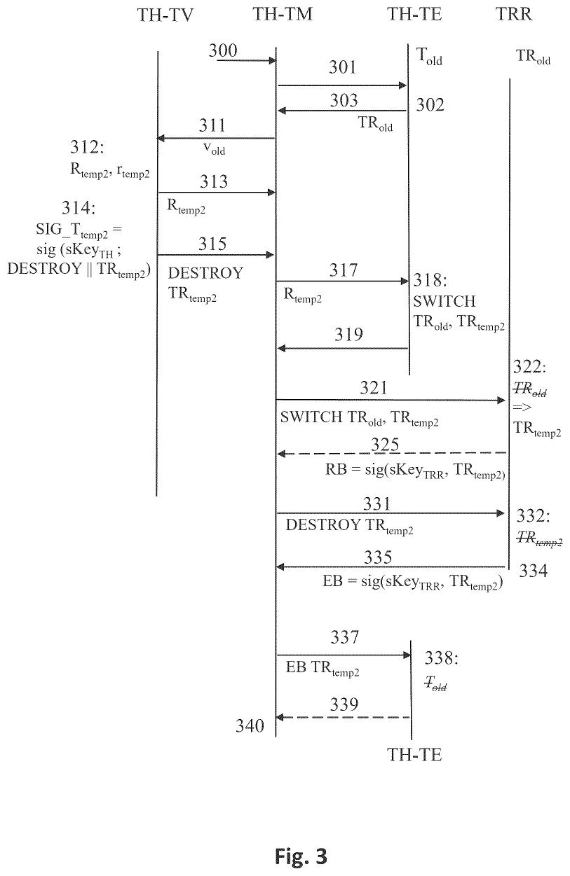

FIG. 3 shows one exemplary embodiment of a sequence of steps of a method according to the second aspect in a token issuer unit;

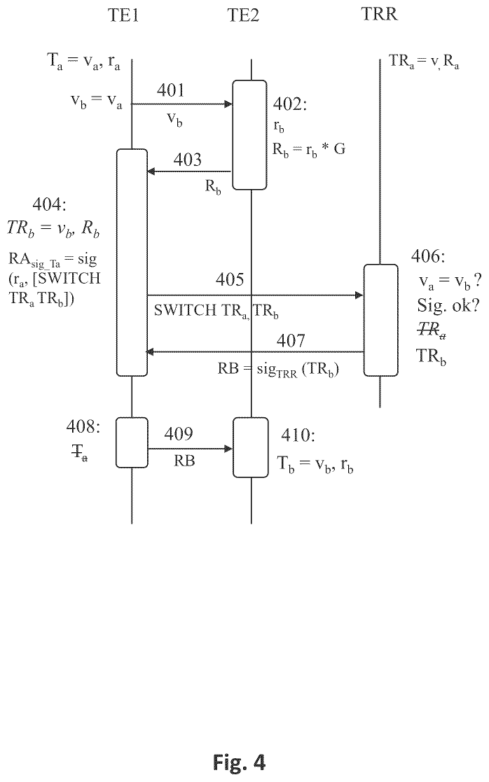

FIG. 4 shows one exemplary embodiment of a flowchart for switching a token;

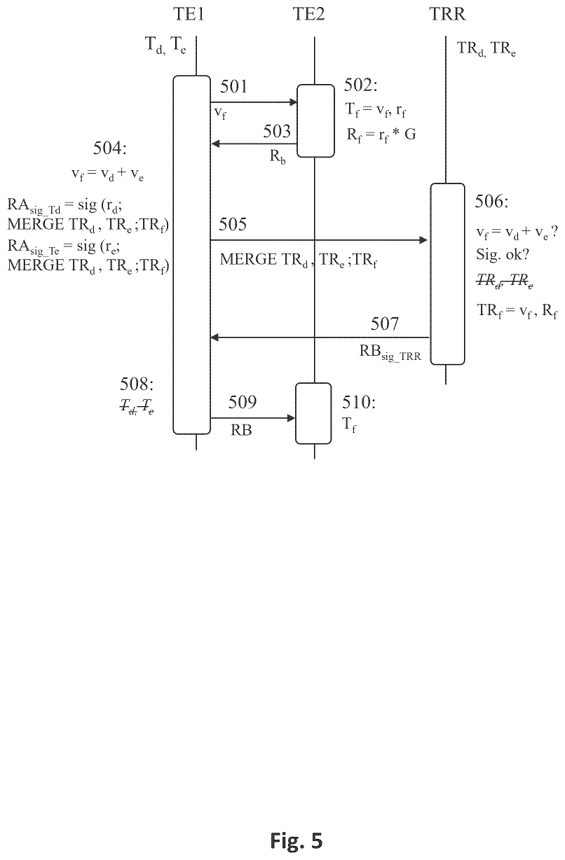

FIG. 5 shows one exemplary embodiment of a flowchart for merging a token; and

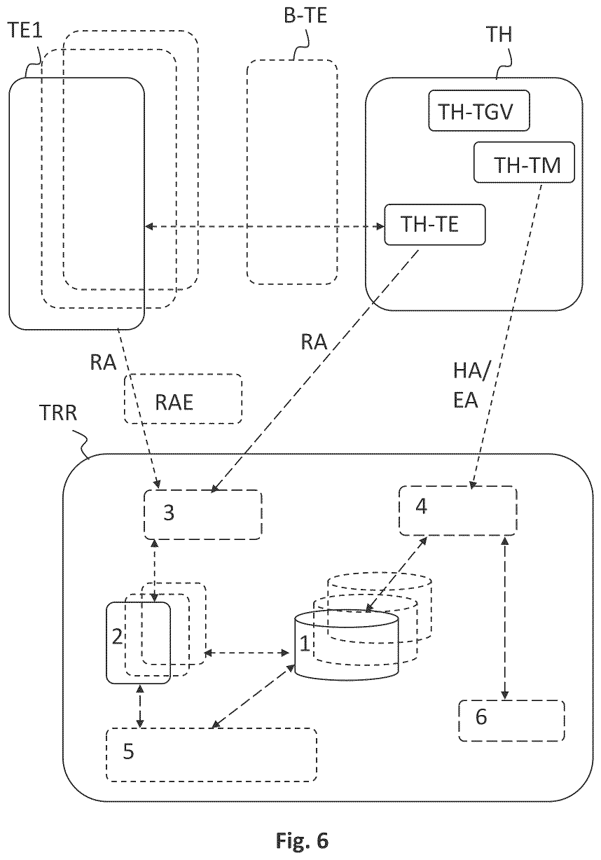

FIG. 6 shows one exemplary embodiment of a transaction system.

FIG. 1 shows one exemplary embodiment of a token issuer TH for a transaction system TS. The transaction system TS may be a digital central bank currency system. The token issuer TH issues tokens T as digital coin data records to a subscriber unit TE, for example directly to a bank customer or preferably to a bank subscriber unit B-TE. The token issuer unit TH provides an initial registration of the newly generated token T (to be issued) in a token reference register TRR of the transaction system TS.

Each token T in the transaction system TS is initially securely generated (only) by the token issuer unit TH (in the TH-TG) and is also securely destroyed (deleted) by the TH (in the TH-TV). A token issuer TH is, for example, an entity of a central bank or an entity of a third-party provider cooperating with a central bank.

On request from a central bank or a subscriber unit TE or a bank subscriber unit (for example a commercial bank), the production (creation, generation) of a token T in the token issuer TH is initiated. For this purpose, the token issuer unit TH of the token issuer has a secure token generation unit TH-TG and a secure token issuer management unit TH-TW and, in some configurations, also a token issuer subscriber unit TH-TE. Both units TH-TG and TH-TW (TH-TE) may be separate from one another and preferably have an air gap AG. The air gap AG serves for ensuring that the highly sensitive security-relevant data and units in the token issuer unit TH, in particular a private key pKey_{TH} and secret token elements r (of a token element pair) of (new) tokens T to be issued, for example private parts of cryptographic key pairs (which are generated by a random number generator), cannot be read out via a network attack on the token issuer TH and used for manipulations of the transaction system TS. The TH-TG may be completely isolated in this case. By way of example, the TH-TG does not have an interface to a network, such as TCP/IP, the Internet, the mobile radio network, etc.

On request from a central bank or a subscriber unit TE or a bank subscriber unit (for example a commercial bank), the destruction (deletion) of a token T in the token issuer TH is initiated. For this purpose, the token issuer unit TH of the token issuer has a secure token destruction unit TH-TV and a secure token issuer management unit TH-TW and, in some configurations, also a token issuer subscriber unit TH-TE. Both units TH-TV and TH-TW (TH-TE) may be separate from one another and preferably have an air gap AG. The air gap AG serves for ensuring that the highly sensitive security-relevant data and units in the token issuer unit TH, in particular a private key pKey_{TH} and secret token elements r (of a token element pair) for tokens T to be deleted, for example private parts of cryptographic key pairs (which are generated by a random number generator), cannot be read out via a network attack on the token issuer unit TH and used for manipulations of the transaction system TS. The TH-TV may be completely isolated in this case. By way of example, the TH-TV does not have an interface to a network, such as TCP/IP, the Internet, the mobile radio network, etc.

A token issuer unit TH can have both a TH-TG and a TH-TV. Alternatively, it is possible for a first token issuer unit of the TS to have only a TH-TG but no TH-TV, and for a second token issuer unit of the TS to have only a TH-TV but no TH-TG.

A token T is uniquely represented in the transaction system TS by a token value v and a secret token element, for example a random number r. The token value v can be specified in a value range from 1 to 2³¹-1. The random number r can be a number in the range from 0 to 2²⁵⁶-1, that is to say the order of an elliptical curve, for example secp256r1.

The random number r—as an example of a secret token element of a token T—is in this case a private part of a token-specific key pair r, R. The random number r is unique and secret in the transaction system TS and must not be published or reused. The generation of the random number r must not be predictable and is generated by means of a true random number generator.

By way of example, the token value v is a 32-bit token element of the integer type. By way of example, the random number r is a 32-byte token element of the integer type.

A token can be stored as a TLV-coded data record in a token memory, for example in the CBS, and then has a unique tag and length information, for example in the following format.

| | Tag | | Token | Public token |
|---|---|---|---|---|
| Name | (hex) | Length | value v | element r |
| TLV-coded | 42 | 1 byte | 4 byte | 32 byte |
| toker | | | | |

An example of a TLV-coded token in hexadecimal form is shown below:
42 24 00 00 40 00 00 01 02 03 04 05 06 07 08 09 0A OB OC OD OE OF 10 11 12 13 14 15 16 17 18 19 1A 1B 1C 1D 1E 1F

and is interpreted as follows:
“42” is the tag for identifying the TLV-coded token T;
“24” indicates the length, that is to say here that it is a 36-byte data record;
“00 00 40 00” is the token value (integer) v=16384 and is accordingly €163.84;
“00 01 02 03 04 05 06 07 08 09 . . . 1D 1E 1F” is the random number r as an integer.

For securely generating a token which can be issued by a token issuer of an electronic transaction system TS with a token reference register TRR, the following steps of the method according to the first aspect of the invention are also carried out with reference to FIG. 2.

In step 200, a token generation request is optionally received at the TH-TM. The token generation request may be sent by a central bank entity. This request can be for an individual token T or a series of tokens T, for example “Generate 200 tokens with a value of 100”. The request may relate to a period of time, for example “Generate 200 tokens with a value of 100 for today” or “Generate 200 tokens with a value of 100 in the next hour”.

In step 201, a request for a new token reference element is optionally received. This request can be received in the TH-TM or from the TH-TM at the TH-TE.

In step 202, a new token element pair R_{new}, r_{new} is optionally generated. A token element pair r, R comprises in particular a secret token element r (a token element of the token T) of the token element pair and a public token reference element R (a token element of the token reference TR) of the token element pair.

In step 203, the public token reference element R_{new} is optionally provided (sent) within the (or to the) TH-TM.

The optional steps 200-203 may proceed differently in this case. According to the sequence shown in FIG. 2, a general request 200 from the central bank “We need 200 tokens with a value of 100 today” or a request for a bank subscriber unit B-TE “We now need 20 tokens with a value of 50” can be received in the TH-TM.

However, a request from a bank, for example a B-TE, “A token with a value of 100 for R_new please” could also-alternatively-already comprise a new public token reference element R_{new}; TH-TE is then not involved in the generation of the new token (to be issued). In this case, the B-TE (external to the TH) generates the new token element pair R_{new}, r_{new} in step 202. In step 203, the B-TE sends the request to the TH-TM. In this case, advantageously, no TH-TE would be necessary in the TH, and the architecture of the TH would be less complex.

In step 211, a token generation request is then received from the TH-TM at the TH-TG.

In step 212, an internal temporary token element pair Rₜₑₘₚ, rₜₑₘₚ is generated. The secret token element rₜₑₘₚ of the internal temporary token element pair is preferably present only in the token generation unit TH-TG.

In step 214, an add command is generated in the TH-TG. A signature of the TH can be used for this purpose. The add command can be signed with a key of the TH and is, for example:

$${SIG\_T}_{temp} = sig ( {sKey}_{TH} ; CREATE ‖ {TR}_{temp} )$$

In step 215, the add command is sent by the secure token generation unit TH-TG to the TH-TW. The command instructs the token reference register TRR to add a token reference TR comprising the generated public token reference element as an additional token reference TR in the token reference register TRR.

A replace command is generated in step 218. The command instructs the TRR to register the token reference TR_{new} of the token T_{new} which can be issued instead of the token reference TRₜₑₘₚ of the temporary token element pair. The replace command can be signed with the secret token element and is, for example:

$${SIG\_T}_{new} = sig ( {r}_{temp} ; SWITCH ‖ {TR}_{temp} , {TR}_{new} )$$

A replacement means any amount-neutral modification of the token, in particular a switch command, but also a merge command of the token T_{new} with a token with a token value of v=0 or else splitting of the token Tₜₑₘₚ into a token T_{new} and a token with a token value of v=0.

In step 219, the replace command is sent from the TH-TG to the TH-TM.

In step 221, the add command is sent to the TRR. The TRR then adds the temporary token reference TRₜₑₘₚ to the database in step 222. The add command is, for example:

$$CREATE {TR}_{temp}$$

In step 224, an addition confirmation HB is optionally generated by the TRR. The HB may be signed with a key of the TRR and is, for example:

$$HB = sig ( {sKey}_{TRR} ; {TR}_{temp} )$$

In step 225, the addition confirmation HB is then optionally received from the TRR in the TH-TM.

In step 231, the replace command is then sent to the TRR. The replace command is, for example:

$$SWITCH {TR}_{temp} , {TR}_{new}$$

In step 232, the token reference TRₜₑₘₚ is then replaced with the token reference TR_{new}.

In step 234, a replacement confirmation RB is then optionally generated. The RB may be signed with a key of the TRR and is, for example:

$$RB = sig ( {sKey}_{TRR} ; {TR}_{new} )$$

In step 235, the replacement confirmation RB is received from the TRR in the TH-TM.

In step 237, the replacement confirmation EB is optionally received in the TH-TE. The RB may be:

$$RB ( {TR}_{new} ) , {v}_{new}$$

In step 238, the new token T_{new} is optionally stored/activated.

In step 239, a confirmation for new tokens T_{new} which can be issued is optionally sent.

In step 240, the completion of the generation is optionally stored in the TH-TM, a type of logging of the generation of the new token T_{new}. The TH-TM accordingly notes the completion of the generation in step 240.

In step 250, the new token T_{new} is optionally output to a B-TE or another TE of the TS.

In one configuration of FIG. 2, step 215 is optional, since the commands of steps 214 and 218 can be transmitted together. Then, steps 221, 231 would be a joint transmission of the two commands and, in the case of joint transmission, either only confirmation step 225 or only confirmation step 235 or both confirmation steps 225 and 235 would take place.

In a further configuration of FIG. 2, step 231 is carried out by the TH-TE or even by the B-TE.

In a further configuration of FIG. 2, step 221 is received in the TRR only from the TH, that is to say from the TH-TM or TH-TE. Then, the sequences of steps 237, 238, 239 change accordingly to the effect that the replacement confirmation RB can only come from TH-TE or B-TE, such that v_{new} and/or RB arrives at the TH-TM in step 237, and step 238 serves to ensure that the new token T is complete or is activated as being able to be issued.

In one configuration, the following method may be executed in order to generate a new token.

The TH-TM requests the public key R_{new} of a new token T_{new} from a processor (payment processor) (TH-TE). The payment processor (TH-TE) stores the associated private key r_{new} in a temporary wallet.

The TH-TM creates a “minting order”, that is to say a request to the TH-TG to provide a new token, and transmits the token value v and the public key R_{new} (from step 1) to the TH-TG in this request.

The TH-TG creates a temporary token Tₜₑₘₚ consisting of the token value v and a temporary private key part rₜₑₘₚ of a temporary token-specific key pair using a CREATE command.

The TH-TG switches (=SWITCH command) from the temporary token Tₜₑₘₚ to the new token T_{new}. For the switching, the TH-TG requires only the public key R_{new} made available by the TH-TM. A registration request is created and contains the command history (CmdHist) of the switch command and of the create command. The token value v and the private key rₜₑₘₚ and the registration request RA are made available to the TH-TM.

The TH-TM sends the registration request RA to the TRR and receives a registration confirmation RB.

The registration confirmation RB and also the registration request RA are sent to the payment processor TH-TE.

The token value v, private key rₜₑₘₚ, registration request RA and registration confirmation are checked and verified in the payment processor TH-TE. The private key r_{new} is removed from the temporary wallet and stored together with v_{new} as T_{new}.

For each token T, a token reference TR is stored in the token reference register TRR. The token reference TR comprises the token value v of the assigned token T and a public part R of the token-specific key pair. The token reference TR of the token T can be seen at any time in the register TRR of the transaction system TS. The token value v of a token T is thus revealed by the token reference register TRR.

The public part R of the token-specific key pair is generated by applying a cryptographic function to the private part r of the token-specific key pair. This function is difficult to reverse and thus gives the transaction system TS the required security. R=r * G, where G may be, for example, a global parameter of the transaction system TS, for example a generator point of an elliptical curve, in this case the secp256r1 curve.

The token reference TR is then formed by the token value v of the token T and the public part R of the key pair. The token reference TR is thus the combination or concatenation of the token value v and the public part R.

This token reference TR can be sent as a registration request RA, possibly together with a command relating to the token T, to the token reference register TRR.

In addition, the registration request RA may be signed with the private part r of the token-specific key pair. The signing makes it possible to verify whether the sender of the token reference TR was in possession of the token T, thus further increasing the security in the transaction system TS.

The signed registration request RAsig is stored in the subscriber unit TE as a so-called proof data record, PR (for proof), for example in the following format:

| | | | |
|---|---|---|---|
| | Tag | | |
| Type | (hex) | Length | Data |

| | | |
|---|---|---|
| PR | 4A | N bytes |

An example of a PR (=RA_{sig}) in hexadecimal form is shown below:
4A 81 8F 03 11 12 13 14 15 16 17 18 19 1A 1B 1C 1D 1E 1F 20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56 30 46 11 12 13 14 15 16 17 18 19 1A 1B 1C 1D 1E 1F 20 21 22 23 24 25 26 27 28 29 2A 2B 2C 2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56

and is interpreted as follows:
“4A” is the tag for identifying the TLV proof RA_{sig_Th};
“81 8F” indicates the length;
“03” indicates that it is a SWITCH registration request;
“11 12 13 14” is the token value vₐ;
“15 16 17 18 19 1A 1B IC ID 1E 1F 20 21 22 23 24 25 26 27 28 29 2A 2B 2C 2D 2E 2F 30 31 32 33 34 35” is the public part Rₐ;
“36 37 38 39 3A 3B 3C 3D 3E 3F 40 41 42 43 44 45 46 47 48 49 4A 4B 4C 4D 4E 4F 50 51 52 53 54 55 56” is the public part Rₕ;
“30 46 11 12 13 14 15 16 17 18 19 1A 1B IC ID 1E 1F 20 21 22 23 24 25 26 27 28 29 2A 2B 2C2D 2E 2F 30 31 32 33 34 35 36 37 38 39 3A 3B 3C 3D 3E 3F 40 41 42 43 44 45 46 47 48 49 4A 4B 4C 4D 4E 4F 50 51 52 53 54 55 56” is the signature as an X690 sequence.

This registration request RA may be sent to the token reference register TRR. This registration request RA is received in the token reference register TRR. After the registration request RA has been checked by the token reference register TRR, the token reference TR is stored in the token reference register TRR, as a result of which the token T is registered in the transaction system TS. From this point in time, the token T can be used in the transaction system TS.

This token reference TR is uniquely assigned to the token T and serves for registering the token T in the transaction system TS. The token reference TR is accordingly the public representation of the token T. The sole knowledge or only the possession of the token reference TR does not allow the token T to be transmitted and is not synonymous with the TE being in possession of the token T. The token reference TR serves to prevent multiple output attempts and checks whether token values v have been generated in an impermissible manner. Therefore, the token reference TR and possibly the history of the tokens T and the corresponding registration requests RA from subscriber units TE are stored in the token reference register TRR.

The tokens T are stored, for example, in electronic wallets. These wallets are, for example, software applications within the subscriber units TE or a terminal in which the subscriber unit is installed in a ready-to-operate manner. A wallet can be set up as an application on a smartphone, a smart card or a payment terminal. The wallet serves to securely manage tokens T of the subscriber unit, to generate token references TR, to modify tokens T and/or to exchange tokens T. Wallets serve to communicate with the token reference register TRR, to generate registration requests RA to the token reference register TRR and/or to perform a transaction of tokens T with respect to a subscriber unit TE.

For a direct transaction of tokens T, it is not necessary for there to be a communication connection to the token reference register TRR of the transaction system TS. The transaction system TS is configured to perform a transaction “offline”, that is to say without a communication connection to the token reference register TRR. A corresponding registration of tokens T can therefore temporally follow a transmission of the token T to a subscriber unit TE.

The token reference register TRR is a unit of the transaction system TS and is either a central register or a central database of the transaction system TS or a decentralized register or a decentralized database (DLT) of the transaction system TS.

The token reference register TRR manages, in particular, the storage location for the token references TR, represented as an example of a storage unit in the token reference register TRR. This is represented by the TR for the token T of the subscriber unit TE1 being entered in the database 1.

Moreover, the token reference register TRR can comprise at least one verification unit 2. The verification unit 2 of the token reference register TRR verifies registration requests RA. In this case, syntactic correctness or else the correct specification of a command in the registration request RA can be verified. A history of old (past) registration requests RA with respect to a token T can also be verified in this case. The separation of this verification unit 2 from the database 1 distributes the tasks of storing and checking and increases the speed in the token reference register TRR.

In addition, the token reference register TRR can comprise a checking unit (not explicitly illustrated) which checks whether a total token value Σ in the transaction system TS is changed with the token value v of a received token reference TR. If this is the case, a new token value v has been created or an existing token value v has been destroyed. Only privileged units, such as an issuer entity TH, are allowed to do this in the transaction system TS. If such a change in the total sum of the token values that is caused by a token reference TR of a subscriber unit TE is detected, a case of fraud can be assumed. Thus, illegal generation of token values v can be discovered and prevented very easily.

The checking of the total token value by the checking unit represents a further security concept in the transaction system TS.

A registration request RA is preferably signed with the private part r. The signature allows the receiver (TRR or TE) to easily check syntactic authenticity of the command. This check is preferably carried out in the database 1 or the verification unit 2. Moreover, a register request RA can be validated syntactically, for example, by checking the signature and/or the token reference TR.

Even if a signature can be checked in a subscriber unit TE, this does not ensure that multiple output of the same token T has not been attempted. Therefore, the registration in the token reference register TRR is provided. In addition, the subscriber units TE provide a secure hardware platform. With an available connection to the token reference register TRR, the token references TR are transmitted, and the multiple output attempt can be discovered in the token reference register TRR.

If a token reference TR is not yet known in the token reference register TRR, it is added.

FIG. 3 describes a method sequence for destroying a token T from the transaction system TS. In order to prevent the token T_{old} to be destroyed (=to be deleted) from being stolen during transfer to the TH-TV, a replace command is combined according to the invention with the remove command.

In step 300, a token destruction request is optionally received. The token destruction request may be sent by a central bank entity. This request can be for an individual token T_{old} or a series of tokens T_{old}, for example “Destroy 200 tokens with a value of 100”. The request may relate to a period of time, for example “Destroy 200 tokens with a value of 100 for today (or in the next hour)”.

In step 301, a request for an old token reference element is optionally received. This request can be received in the TH-TM or from the TH-TM at the TH-TE.

In step 302, the old token(s) T_{old} is/are optionally deactivated in the TH-TE.

In step 303, the old token reference element TR_{old} is optionally sent.

Steps 300-303 may proceed differently. According to the sequence in FIG. 3, a general request 300 from the central bank “We are deleting 200 tokens with a value of 100 today” or a request for a bank “We are now deleting 20 tokens with a value of 50” can be received in the TH-TM.

However, a request from a bank, for example a B-TE, “Please delete a token with a value of 100 for R_{old}” could also—alternatively—already comprise a public token reference element R_{old} to be deleted; TH-TE is then not involved in the destruction of the token T_{old} to be deleted. In this case, the B-TE (external to the TH) labels the R_{old} in step 302. In step 303, the B-TE sends the request to the TH-TM. In this case, advantageously, no TH-TE would be necessary in the TH, and the architecture of the TH would be less complex.

In step 311, a destruction request is optionally received from the TH-TM at the TH-TV.

In step 312, a temporary token element pair Rₜₑₘₚ₂, rₜₑₘₚ₂ is generated.

In step 313, the temporary token reference element Rₜₑₘₚ₂ is sent from the TH-TV to the TH-TM.

A remove command is generated in step 314. The remove command can be signed with the key of the TH and is, for example:

$${SIG\_T}_{temp 2} = sig ( {sKey}_{TH} ; DESTROY ‖ {TR}_{temp 2} )$$

In step 315, the generated remove command is sent by the secure token destruction unit TH-TV. The remove command instructs the token reference register TRR to remove a token reference of a registered token from the token reference register TRR.

In step 317, the temporary token reference element Rₜₑₘₚ₂ is received from the TH-TM in the TH-TE.

A replace command is generated in step 318. The command serves to instruct the TRR to register the token reference TRₜₑₘₚ₂ of the internal temporary token Tₜₑₘₚ₂ instead of the token reference TR_{old} of the token T_{old} to be withdrawn. The replace command is, for example:

$$SWITCH {TR}_{old} , {TR}_{temp 2}$$

Replacement means any amount-neutral modification of the token, in particular a switch command, but also a merge command of the token with a token with a token value of v=0 or else splitting of the token into a token and a token with a token value of v=0.

In step 319, the replace command generated is sent from the TH-TE to the TH-TM.

In step 321, the replace command from step 318 is sent from the TH-TM to the TRR.

In step 322, the token reference TRold is replaced with the token reference TRₜₑₘₚ₂ in the TRR.

In step 325, a replacement confirmation is optionally received from the TRR at the TH-TM. The replacement confirmation RB may be signed with a key of the TRR and is, for example:

$$RB = sig ( {sKey}_{TRR} , {TR}_{temp 2} )$$

In step 331, the remove command is then sent from the TH-TM to the TRR. The remove command is, for example:

$$DESTROY {TR}_{temp 2}$$

In step 332, the temporary token reference TRₜₑₘₚ₂ is then removed in the TRR. In step 334, a removal confirmation EB is optionally generated.

In step 335, the removal confirmation EB generated in step 334 is optionally received from the TRR at the TH-TM. The EB may be signed with a key of the TRR and is, for example:

$$EB = sig ( {sKey}_{TRR} ; {TR}_{temp 2} )$$

In step 337, the forwarded removal confirmation EB is optionally received at the TH-TE.

In step 338, the old token T_{old} is deleted in the TH-TE.

In step 339, a deletion confirmation is optionally received.

In step 340, the completion of the destruction is optionally stored in the TH-TM.

In one configuration of FIG. 3, step 315 is optional, since the commands of steps 321 and 331 can be transmitted together and, in the event of joint transmission, either only step 325 or only step 335 or both steps 325 and 335 would take place.

In one configuration, the following method may be executed in order to destroy a token.

The TH-TM identifies a token T_{old} which is present in the payment processor (in a storage area specifically provided for this purpose, or in a TH-TE) and is intended to be deleted.

The TH-TM requires the TH-TV to export a public key Rₜₑₘₚ₂ for the token T_{old} to be deleted. The TH-TV stores the corresponding private key rₜₑₘₚ₂ in its secure memory.

In the TH-TM, a) a switch command from T_{old} to Tₜₑₘₚ₂ is executed, creating a registration request RA, b) the registration request RA is sent to the TRR, and c) a registration confirmation is received from the TRR with confirmation of the registration of the switch.

The TH-TM exports a delete request to the TH-TV (“melting order”) for deleting (destroying) the token Tₜₑₘₚ₂ and attaches the registration request RA and registration confirmation RB from the TRR.

The TH-TV verifies the delete request, registration request RA and registration confirmation RB from the TRR. The CMS executes a DELETE command (DESTROY) on the token Tₜₑₘₚ₂ using the private key pKey_{TH} of the TH-TV and the private key rₜₑₘₚ₂.

The TH-TV exports the delete command to the TH-TM to create a registration request RA.

The TH-TM sends the registration request RA with respect to the DELETE command to the TRR. From the registration of the DELETE command in the TRR, the token Tₜₑₘₚ₂ is deleted (it no longer exists for the TRR).

The delete operation may be a fully automatic process without manual interaction. If an air gap AG is also required here (if appropriate system requirement), batch processing (batch run) may be performed for all tokens to be deleted, in which all required public keys are requested in advance from the CMS, for example at the end of a business day (for the deletions on the business day). Alternatively, all tokens to be deleted are first combined (merged) and only a merged token is finally deleted.

Each command can be signed in order to be able to check that the sender of the token reference TR is also in possession of the associated token T. An ECDSA scheme may be used as a signature. A command is preferably signed with the secret token element, for example the private part r, of the token T. For “create” and “delete” commands, a further signature of the token issuer unit TH may be required in order to ensure that these commands have been generated by a privileged unit of the transaction system TS.

FIG. 4 shows an exemplary embodiment of a flowchart of a method for transmitting a token T between a TE1 and a TE2 on the basis of a switch command for an existing token Tₐ. The signed registration request RA_{sig_Ta} required for this purpose and a registration confirmation RB with a command structure are also shown.

A token Tₐ is present in the TE1. The token Tₐ has a token value vₐ and the private part r of the token-specific key pair. The associated token reference TRₐ is registered to the TE1 in the token reference register TRR. A token T_{b} with the token value v_{b} is intended to be transmitted between TE1 and TE2.

For this purpose, the TE1 sends transmission information Ü or token information (for example the token value v_{b} itself) to the TE2. This token information can be a declaration of intent from TE1 to TE2 to transmit the token T_{b}—for example as part of a payment transaction. TE2 then generates a new random number r_{b} which serves as a private part (the secret) of a new cryptographic token-specific key pair. By applying a cryptographic one-way function, the public part R_{b} of the key pair is generated in the TE2.

TE2 then sends the public part R_{b} of the key pair back to TE1. If TE2 is already aware of the token value v_{b} (for example the token value expected as part of the payment transaction or the token information provided by TE1 is the token value v_{b}), TE2 can also send the token reference TR_{b} to TE1.

In the TE1, the token Tₐ is now switched to the token T_{b} to be transmitted. A registration request RA_{sig_Ta} is then created and sent from the TE1 to the TRR. The registration request RA then contains the command “SWITCH” or a corresponding command code according to FIG. 2a, the input token reference TRₐ and the public part R_{b} and/or the output token reference TR_{b}. This registration request RA is signed with the random number rₐ of the token Tₐ. The signed registration request RA_{sig_Ta} is sent from the subscriber unit TE1 to the token reference register TRR. There, the signature is checked. In addition, the token value vₐ is compared with the token value v_{b}. If vₐ =v_{b} and the signature check is successful, the token reference TRₐ in the token reference register TRR is deleted or marked as deleted and the token reference TR_{b} is entered in the token reference register TRR. From this point in time, the token T_{b} is registered to the TE2.

The success of the registration is indicated by the TRR to the TE1 as a registration confirmation RB. The registration confirmation comprises the token reference TR_{b}. To safeguard the method, this registration confirmation can be provided with a signature of the TRR.

The registration confirmation RB may be sent from the TE1 to the TE2 in order to notify TE2 of the registration success. TE2 can then validate the registration confirmation RB again. The token T_{b} with the token value v_{b} and the private part r_{b} is thus considered to have been transmitted from TE1 to TE2 without the token having to be transmitted from TE1 to TE2 with both token elements.

Accordingly, the generated public part R_{b} is transmitted to TE1. TE1 performs the registration by means of a switch command “SWITCH”. A confirmation RB is sent back, if necessary with the signature of the TRR Sig (v_{b}, R_{b}) for the generated public part R_{b} and the token value v_{b}. Final switching in TE2 thus becomes superfluous, and the method is accordingly less complex.

FIG. 5 shows an exemplary embodiment of a flowchart of a method for merging a token T_{d} with a token Tₑ and registering the merged token T_{f} in the TRR. In addition, the signed registration requests RA_{sig_Td} and RA_{sig_Te} required for this purpose and the command structure are shown in tabular form from the point of view of both the TE layer and the TR layer.

In this case, a random number r_{f} is generated in a TE1 of the TE layer. Based on this, a public part R_{f} is then generated. In addition, a sum of the token values v_{d} and vₑ to form the token value v_{f} is formed on the basis of the input tokens T_{d} and Tₑ.

The output token reference TR_{f} is then generated. A registration request RA then contains the command “MERGE” or the command code listed in FIG. 6a, the two input token references TR_{d} and TRₑ and the output token reference TR_{f}. This registration request RA is signed once with the random number r_{d} of the token T_{d} in order to obtain a first signed registration request RA_{sig_Td}. This registration request is also signed with the random number rₑ of the token Tₑ in order to obtain a second signed registration request RA_{sig_Te}. Both signed registration requests RA_{sig_Td} and RA_{sig_Te} are sent from the subscriber unit TE1 to the token reference register TRR. There, the signatures of the registration requests RA_{sig_Td} and RA_{sig_Te} are checked in each case. In addition, the sum of the token values v_{d} and vₑ is formed and compared with the token value v_{f}. If v_{f}=v_{d}+vₑ and both signature checks are successful, TR_{d} and TRₑ are deleted or marked as deleted in the token reference register TRR and the token reference TR_{f} is entered in the token reference register TRR. The merged token T_{f} (which was transmitted from TE1 to TE2 in the meantime) can now be checked for validity by the subscriber unit TE2 in the TRR.

FIG. 6 shows a further configuration of a token reference register TRR of a transaction system TS. It is indicated here that a plurality of storage units 1 can be maintained in the token reference register TRR in order to accelerate storage of a multiplicity of token references TR. It is also indicated here that a plurality of verification units 2 can be maintained in the token reference register TRR in order to accelerate verification of registration requests RA. A subscriber unit B-TE, which is arranged as a special bank subscriber unit between the token issuer TH and the subscriber unit TE1, is also shown.

Moreover, FIG. 6 shows a registration request unit RAE which can receive a sequence of registration requests RA from a subscriber unit TE1.

It is advantageous if only one token T is used per subscriber unit TE (here as a secure element, for example smart card or TEE). This means that the subscriber unit TE merges a received token T with the token T stored in the token memory (MERGE). This also means that the subscriber unit TE separates a token T to be sent from the token T stored in the token memory (SPLIT). These modifications to the token T can be performed without a registration request RA and the token T can be forwarded immediately after a modification. Thus, there may be a sequence of modifications to the token T that are not known to the TRR. Typically, the sequence of registration requests RA consists of a combination of SPLIT and MERGE modifications. Each of these modifications is also stored as “proof” (see above for FIG. 1) or a signed registration request RA_{sig} with the token T. This results in a sequence of registration requests RA_{F} in the subscriber unit TE.

### LIST OF REFERENCE SIGNS

TS Transaction system
TH Token issuer unit
TH-TG Token generation unit
TH-TV Token destruction unit
TH-TM Token issuer management unit
TH-TE Token issuer subscriber unit
AG Air gap
TE1 Subscriber unit user
B-TE Bank subscriber unit
TRR Token reference register
T Token
TR Token reference
R, r Token element pair
R Public token reference element of the token element pair
r Secret token element of the token element pair
v Token value
HB Addition confirmation
RB Replacement confirmation
EB Removal confirmation
SKEy_{TH} Private part of the token issuer key pair
200 Receive token generation request
201 Receive request for new token reference element
202 Generate a new token element pair
203 Send the public token reference element
211 Receive a token generation request
212 Generate a temporary token element pair
214 Generate an add command
215 Send the add command
218 Generate a replace command
219 Send the replace command
221 Send the add command to TRR
222 Add the temporary token reference
224 Generate an addition confirmation
225 Receive the addition confirmation from TRR
231 Send the replace command to TRR
232 Replace the token references
234 Generate a replacement confirmation
235 Receive the replacement confirmation from TRR
237 Receive the replacement confirmation
238 Store/activate the new token
239 Send confirmation for new token which can be issued
240 Store completion of the generation
250 Output the new token
300 Receive a token destruction request
301 Receive request for old token reference element
302 Deactivate old tokens
303 Send the old token reference element
311 Receive a destruction request
312 Generate a temporary token element pair
313 Send the temporary token reference element
314 Generate a remove command
315 Send the generated command
317 Receive the temporary token reference element
318 Generate a replace command
319 Send the generated command
321 Send the replace command to TRR
322 Replace the token references
325 Receive a replacement confirmation from TRR
331 Send the remove command
332 Remove the temporary token reference
334 Generate a removal confirmation
335 Receive the removal confirmation from TRR
337 Receive the forwarded removal confirmation
338 Delete the old token
339 Receive deletion confirmation
340 Store completion of the destruction

1.-17. (canceled)

18. A method for securely generating a token which can be issued by a token issuer of an electronic transaction system with a token reference register,
wherein, in a token issuer unit comprising a secure token generation unit, the following steps are carried out:
generating a token-specific token element pair, comprising a secret token element and a public token reference element, in the secure token generation unit;
generating an add command in the secure token generation unit, said command instructing the token reference register to add a token reference comprising the generated public token reference element as an additional token reference in the token reference register;
sending the add command to the token reference register;
wherein
the generated token element pair is an internal temporary token element pair of the token generation unit,
the token generation unit receives a token reference of the token which can be issued, and
the token generation unit generates a replace command which instructs the token reference register to register the token reference of the token which can be issued instead of the token reference of the temporary token element pair.

19. The method according to claim 18, wherein the token issuer unit comprises a secure token storage unit,
wherein the secure token storage unit generates a token-specific token element pair of the token which can be issued.

20. The method according to claim 18, wherein the secret token element of the internal temporary token element pair is present only in the token generation unit; and/or the secret token element of the token which can be issued is present only in the token generation unit.

21. The method according to claim 18, wherein the add command and the replace command are sent together to the token reference register in a joint sending step.

22. The method according to claim 21, wherein, as a result of the sending, an addition confirmation and/or a replacement confirmation is/are received in the token issuer unit.

23. The method according to claim 18, wherein the token issuer unit comprises a secure token management unit,
wherein a token generation request is received in the secure token management unit.

24. The method according to claim 23, wherein the token generation request already comprises the public token reference element.

25. A method for securely destroying a token by a token issuer of an electronic transaction system with a token reference register,
wherein, in a token issuer unit comprising a secure token destruction unit, the following steps are carried out:
generating a remove command in the token destruction unit, said command instructing the token reference register to remove a token reference of a registered token from the token reference register;
sending the remove command to the token reference register;
wherein
the token destruction unit generates an internal temporary token before generating the remove command and generates the remove command for the token reference of the internal temporary token; and
generating a replace command which instructs the token reference register to register the token reference of the internal temporary token instead of the token reference of the token to be withdrawn.

26. The method according to claim 25, wherein the token issuer unit comprises a secure token storage unit,
wherein the secure token storage unit deactivates the token to be withdrawn.

27. The method according to claim 25, wherein the secret token element of the internal temporary token is present only in the token destruction unit.

28. The method according to claim 25, wherein the remove command and the replace command are sent together to the token reference register in a joint sending step.

29. The method according to claim 28, wherein, as a result of the sending, a removal confirmation and/or a replacement confirmation is/are received in the token issuer unit.

30. The method according to claim 18, wherein the token issuer unit comprises a secure token management unit,
wherein a token destruction request is received in the token management unit.

31. A token issuer unit comprising a secure token generation unit for securely generating a token which can be issued by means of a method according to claim 18; and
an interface to a token reference register.

32. The token issuer unit according to claim 31, further comprising:
a token issuer subscriber unit configured to store tokens and/or token references; and
an interface to a bank subscriber unit or to a central bank unit, configured to receive a token generation request and/or to receive a token destruction request.

33. The token issuer unit according to claim 31, comprising:
a token management unit with an interface to a bank subscriber unit or to a central bank unit or a token issuer subscriber unit, configured to:
output the token which can be issued; and/or
store completion of the secure destruction of the token and/or
store completion of the secure generation of the token which can be issued.

34. The token issuer unit according to claim 3, further comprising an air gap interface between the token management unit and the secure token generation unit and/or the secure token destruction unit.

35. A token issuer unit comprising a secure token destruction unit for securely destroying a token by means of a method according to claim 25; and
an interface to a token reference register.

36. The token issuer unit according to claim 35, further comprising:
a token issuer subscriber unit configured to store tokens and/or token references; and
an interface to a bank subscriber unit or to a central bank unit, configured to receive a token generation request and/or to receive a token destruction request.

37. The token issuer unit according to claim 35, comprising:
a token management unit with an interface to a bank subscriber unit or to a central bank unit or a token issuer subscriber unit, configured to:
output the token which can be issued; and/or
store completion of the secure destruction of the token and/or
store completion of the secure generation of the token which can be issued.
